(19) United States
(12) Patent Application Publication
(10) Pub. No.: US 2012/0284063 A1
(43) Pub. Date: Nov. 8, 2012

(54) SYSTEM AND METHOD FOR PROVIDING A TRAVEL ECOSYSTEM WITH SHARING OF SOCIAL TRAVEL PREFERENCES

(76) Inventor: William Angelo Almonte, West Palm Beach, FL (US)

(21) Appl. No.: 13/465,514

(22) Filed: May 7, 2012

Related U.S. Application Data
(60) Provisional application No. 61/483,620, filed on May 6, 2011.

(51) Int. Cl. G06Q 50/14

(52) U.S. Cl. 705/5

(57) ABSTRACT

The present invention generally relates to web based travel platforms. Specifically, this invention relates to a system and method for providing a web based travel platform that allows travel agencies, agents, suppliers and vendors to communicate and collaborate within a single global platform and share social travel preferences.

Numerous methods are described herein for the provision of and functionalities provided by such a web based travel platform.

### CROSS-REFERENCE TO RELATED APPLICATIONS

This application claims the benefit of the following provisional applications, each of which is hereby incorporated by reference in its entirety: U.S. patent application Ser. No. 61/483,620 filed on May 06, 2011 and entitled “SYSTEM AND METHOD FOR PROVIDING A TRAVEL ECOSYSTEM.”

### FIELD OF THE INVENTION

The present invention generally relates to web based travel platforms. Specifically, this invention relates to a system and method for providing a web based travel platform that allows travel agencies, agents, suppliers and vendors to communicate and collaborate within a single global platform. Numerous methods are described herein for the provision of and functionalities provided by such a web based travel platform.

### BACKGROUND

While more and more travelers have turned to web-based methods to book their travels and vacations, the proposition of finding and utilizing convenient and synchronized has become increasingly more difficult as the number of travel providers and other service providers continues to increase. As the market becomes more fragmented, the ability to find, book and utilize various travel services at the most convenient manners and discounted prices is actually becoming more and more difficult.

This is becoming all the more true as new methods of rendering and receiving travel services are entering the market all the time. From personal rentals to on-demand transportation services, the market not only increases in number of providers, but ways in which services are made available to the consumer/traveler.

As the number of services and providers goes up, the ability for a user to maintain their preferences and other aspects/details of their personal travel desires decreases. Each time a user wants to utilize a new service, they must input their preferences from scratch. And in cases where the service provider has not provided a method for a user to notify the provider of the user's desires, the user is simply left without the ability to receive the services they are accustomed to as provided by alternate service providers.

Therefore, there is a need in the art for a system and method for providing a web based travel platform that allows travel agencies, agents, suppliers and vendors to communicate and collaborate within a single global platform. These details and other features and advantages of the present invention will be explained and will become obvious to one skilled in the art through the summary of the invention that follows.

### SUMMARY OF THE INVENTION

Accordingly, it is an aspect of the present invention to provide a system and method for providing a web based travel platform that allows travel agencies, agents, suppliers and vendors to communicate and collaborate within a single global platform and share social travel preferences.

According to an embodiment of the present invention, a web-based system for providing a travel ecosystem with social travel preferences includes: a travel preference engine comprising computer-executable code stored in non-volatile memory, a data store and a travel preference communications means; and a communications engine comprising computer-executable code stored in non-volatile memory and a communications engine communications means, wherein said communications engine communications means is configured to communicate data from said travel preference engine to one or more travel providers and one or more travelers, wherein said computer-executable code of said travel preference engine is configured to perform the steps of: receiving one or more travel preferences from said one or more travelers; classifying said one or more travel preferences as pertaining to one or more applicable categories; storing said one or more travel preferences and one or more applicable categories in said data store of said travel preference engine; receiving a request from one or more of said one or more travel providers, wherein said request is to receive information regarding said one or more travel preferences of said one or more travelers; identifying said one or more travel providers from said request, wherein said identification further identifies one or more industries associated with said one or more travel providers; validating one or more of said one or more travel providers based at least in part on information related to said one or more travel providers stored in said data store and a comparable matching between said one or more applicable categories and said information; retrieving, from said data store, one or more of said one or more travel preferences; transmitting to one or more of said one or more travel providers said one or more of said one or more travel preferences.

According to an embodiment of the present invention, the one or more travel providers and one or more travelers are provided user accounts within one or more networks that can be connected to each other for facilitating communication and collaboration there between.

According to an embodiment of the present invention, the user accounts associated with one or more of said one or more travelers comprises a travel preferences section, stored in said data store, listing one or more travel preferences of said one or more of said one or more travelers.

According to an embodiment of the present invention, the user accounts comprise a plurality of sections displaying a plurality of types of information.

According to an embodiment of the present invention, the one or more travel preferences may be selected by said one or more travelers by checking a preference in order to select it.

According to an embodiment of the present invention, the one or more travel preferences may be selected by manual input.

According to an embodiment of the present invention, the validating step requires permission to be granted from said one or more travelers.

According to an embodiment of the present invention, a web-based method for providing a travel ecosystem with social travel preferences, the method comprising the steps of: receiving one or more travel preferences from one or more travelers; classifying said one or more travel preferences as pertaining to one or more applicable categories; storing said one or more travel preferences and one or more applicable categories in a data store of a travel preference engine; receiving a request from one or more travel providers, wherein said request is to receive information regarding said one or more travel preferences of said one or more travelers; identifying said one or more travel providers from said request, wherein said identification further identifies one or more industries associated with said one or more travel providers; validating one or more of said one or more travel providers based at least in part on information related to said one or more travel providers stored in said data store and a comparable matching between said one or more applicable categories and said information; retrieving, from said data store, one or more of said one or more travel preferences; transmitting to one or more of said one or more travel providers said one or more of said one or more travel preferences.

According to an embodiment of the present invention, the one or more travel providers and one or more travelers are provided user accounts within one or more networks that can be connected to each other for facilitating communication and collaboration there between.

According to an embodiment of the present invention, the user accounts associated with one or more of said one or more travelers comprises a travel preferences section, stored in said data store, listing one or more travel preferences of said one or more of said one or more travelers.

According to an embodiment of the present invention, the user accounts comprises a plurality of sections displaying a plurality of types of information.

According to an embodiment of the present invention, the one or more travel preferences may be selected by said one or more travelers by checking a preference in order to select it.

According to an embodiment of the present invention, the one or more travel preferences may be selected by manual input.

According to an embodiment of the present invention, the validating step requires permission to be granted from said one or more travelers.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

Other features and advantages of the present device will be apparent from the accompanying drawings, and from the detailed description, which follows below.

### BRIEF DESCRIPTION OF THE DRAWINGS

FIG. 1 is a schematic overview of a network system for carrying out this invention in accordance with an embodiment of the present invention;

FIG. 2 shows an exemplary embodiment of a private branded portal, in accordance with an embodiment of the present invention;

FIG. 3 shows an exemplary embodiment of administrator controls of private branded portals, in accordance with an embodiment of the present invention;

FIG. 4 shows an exemplary group diagram, in accordance with an embodiment of the present invention;

FIG. 5 shows an exemplary visibility audience diagram, in accordance with an embodiment of the present invention;

FIG. 6 shows a diagram displaying how travel suppliers, vendors and merchants can choose their preferred travel preference categories within the platform or recommend adding additional preference categories based on their needs, in accordance with an embodiment of the present invention;

FIG. 7 shows a diagram displaying how travelers and customers within the web based platform can customize their individual preferences per preference category, in accordance with an embodiment of the present invention;

FIG. 8 shows a diagram of an exemplary embodiment of an Internal B2B Marketing connection, in accordance with an embodiment of the present invention;

FIG. 9 shows a diagram of an exemplary group advertising purchasing method and system in accordance with an embodiment of the present invention; and

FIG. 10 shows a diagram of an exemplary Open Traveler/Consumer Travel Management Application in accordance with an embodiment of the present invention; and

FIG. 11, an exemplary method for providing a travel ecosystem with social travel preferences, in accordance with an embodiment of the present invention, is shown.

### DETAILED SPECIFICATION

The present invention generally relates to web based travel platforms. Specifically, this invention relates to a system and method for providing a web based travel platform that allows travel agencies, agents, suppliers and vendors to communicate and collaborate within a single global platform and share social travel preferences. Numerous methods are described herein for the provision of and functionalities provided by such a web based travel platform.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, tablet computing devices, and servers. One of ordinary skill in the art would understand that any number of computing devices could be used, and embodiments of the present invention are contemplated for use with any computing devices.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

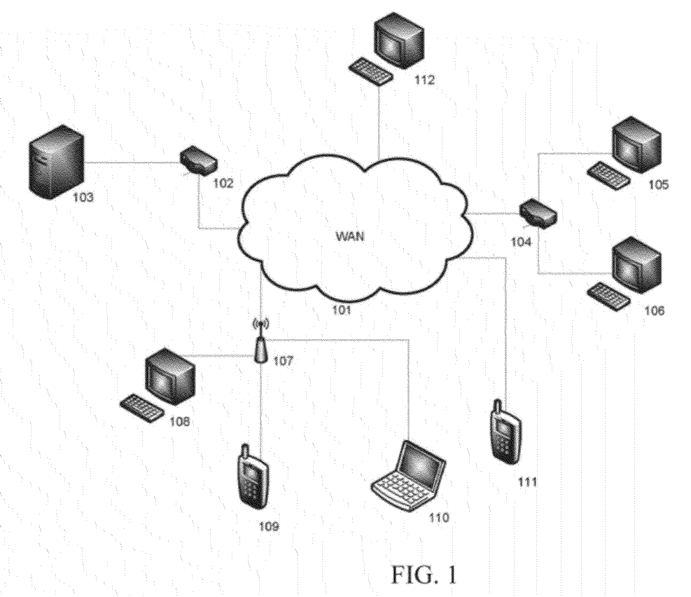

Referring to FIG. 1, a schematic overview of a system in accordance with an embodiment of the present invention is shown. The system is comprised of one or more application servers 103 for electronically storing information used by the system. Applications in the server 103 may retrieve and manipulate information in storage devices and exchange information through a WAN 101 (e.g., the Internet).

According to an exemplary embodiment, as shown in FIG. 1, exchange of information through the WAN 101 or other network may occur through one or more high speed connections directed through one or more routers 102. Router(s) 102 are completely optional and other embodiments in accordance with the present invention may or may not utilize one or more routers 102. One of ordinary skill in the art would appreciate that there are numerous ways server 103 may connect to WAN 101 for the exchange of information, and embodiments of the present invention are contemplated for use with any method for connecting to networks for the purpose of exchanging information.

Users may connect to server 103 via WAN 101 or other network in numerous ways. For instance, a user may connect to the system i) through a computing device 112 directly connected to the WAN 101, ii) through a computing device 105, 106 connected to the WAN 101 through a routing device 104, iii) through a computing device 108, 109, 110 connected to a wireless access point 107 or iv) through a computing device 111 via a wireless connection (e.g., CDMA, GMS, 3G, 4G) to the WAN 101. One of ordinary skill in the art would appreciate that there are numerous ways that a user may connect to Server 103 via WAN 101 or other network, and embodiments of the present invention are contemplated for use with any method for connecting to Server 103 via WAN 101 or other network.

According to an embodiment of the present invention, an individual or organization may signup to become a user of the system herein provided. In an exemplary embodiment, an individual would go through a registration process whereby they would provide identifying information to be stored in application server 103. This identifying information may be used, for instance, to identify the user, verify credentials, secure their login or identify the current location of the user. One of ordinary skill in the art would appreciate there are numerous ways to provide and manage registration processes, and embodiments of the present invention are contemplated for use with any method for providing and managing registration processes.

According to an embodiment of the present invention, once registered, the system and methods herein described provide the registered user with numerous methods and functions for setting up, participating in and interacting with a web based travel platform. Set forth below are some of the functions and methods provided by the present invention.

According to an embodiment of the present invention, the systems and methods herein described may be further enhanced with, and in some cases may require, the utilization of location based services (LBS). LBS are utilized on computing devices capable of determining a user's location via one or more methods. Methods for determining a user's location include, but are not limited to, global positioning systems (GPS), cellular or other wireless transmission triangulation and internet protocol (IP) address determinations. One of ordinary skill in the art would appreciate that there are numerous ways in which to determine the location of a user of a computing device, and embodiments of the present invention are contemplated for use with any manner of determining the location of a user of a computing device.

### EXEMPLARY SYSTEMS AND METHODS

Branded Travel Collaboration Portals, Widgets, Apps and Content Sharing

According to an embodiment of the present invention, the systems and methods herein described provide for an online travel industry network and platform that facilitates communication, collaboration and commercial transactions between travel industry participants comprising travel service providers and customers. The travel service providers can be further categorized into travel agents and agencies, travel suppliers, travel vendors and local merchants. The travel agents and agencies play a role of securing a travel product or service or a travel experience on customers' behalf in exchange for commission. Typically, a travel agent or agency has various business associations with travel suppliers and travel vendors. A travel supplier refers to a business establishment that specializes in a particular travel service or product or products. Examples of travel suppliers include, but are not limited to, airliners, taxi services, hotels, restaurants, spas, cruise lines, local attractions, theme parks, night clubs, car rentals, tour companies, trains, boats, vacation home rentals, and so on. A travel vendor refers to a business establishment that also specializes in a particular product or service, not necessarily travel related, however, the nature of the travel product or service is essentially B2B and or B2C. Local merchant refers to any local shopping store, mall, attraction, food establishment or any other local vendor or merchant who provides a product or service.

According to an embodiment of the present invention, every travel industry participant can be a part of the online web based platform described herein by registering therewith or excepting an invitation from another active customer. The web based platform is configured such that all the participants thereof can be mutually connected and thereby can communicate and collaborate with each other. For example, travel agents can connect with their travel suppliers and thereby keep each other posted with regard to any relevant developments. In the similar way, fellow customers can connect to each other and can socialize. In another example, a customer can connect with a service provider and can receive product updates there from.

According to an embodiment of the present invention, each customer user account comprises a plurality of sections displaying different types of information or content.

Travel Platform in the Aggregate and Cumulative of Combined Applications

According to an embodiment of the present invention, an entire travel platform and included branded portals may provide an aggregate of applications combined into a single web based unified travel platform. The uniqueness of a web based travel platform is in combined infrastructure and unified integration of multiple applications connected together. These applications include, but are not limited to one or more of a: Trip Builder and Planner; Travel Reviews; Company and User Rating System; Company and User Profiles; Destination Pages; Calendar; Web mail; Live Chat; Form Builder; Survey Builder; Alerts; Events; Articles; Quick Links; Content Builder; Local Deals Builder; Teams and Workgroups; Custom Views; File Management; Social CRM; Consumer Web Sites; Status Updates; Advertisement Module; Contest Builder; Quiz Builder; Q&A; FAQ Builder and Knowledgebase; Points System; Badge & Award System; Mobile and Web Travel App Store; Restaurant Reservation Manager; Events and Meetings Manager; Vacation Rental Manager; Tour Manager; Event Ticket Manager; Concierge Manager; Hotel Manager; and Social Media Manager.

Branded Portals/Hubs

According to an embodiment of the present invention, customers may choose to create their own private branded portal or hub within a web based platform. A branded portal or workspace can be comprised of many different elements including content, modules, apps, widgets, online tools and more.

According to an embodiment of the present invention, the systems and methods described herein may allow any type of travel company or merchant the capability to setup a branded private portal including, but not limited to: Retail leisure and corporate agencies; Small home based travel agencies; Host agencies; Tour companies; Hotels; Concierge; Car rental companies; Limo companies; Local tour guides; Local shopping stores; Local attractions; Local events; Cruise lines; Airlines; Travel agency consortiums; GDS and reservation providers; Travel technology providers; Travel consultants; Business consultants; Trade media and press; Local chamber of commerce; Destination marketing companies; Travel bloggers; Travel writers; Travel video and photographers; Travel content providers; Travel developers and designers; Rail companies; Convention bureaus; Restaurants and nightclubs; and Home vacation rentals.

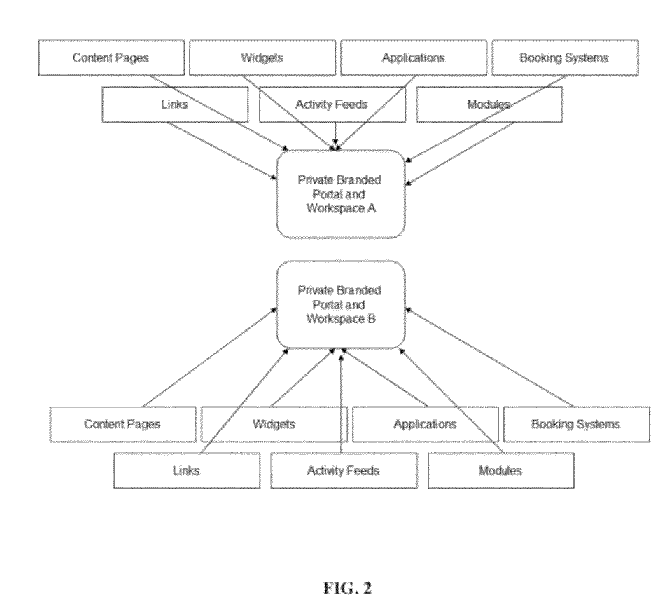

According to an embodiment of the present invention, the systems and methods described herein may allow each company and their private branded portal(s) to create and deploy their own original content. The systems and methods herein described may also be configured to allow each company, and their private branded portal(s) to grab content made available to them from their connected companies and portals. FIG. 2 shows an exemplary embodiment of a private branded portal, in accordance with an embodiment of the present invention.

Connections

According to an embodiment of the present invention, the systems and methods herein described may allow portals to request to connect with any other branded portal within a web based platform. Once both portals agree to connect, they can then share a plurality of content items, widgets, applications, deals, information etc.

Once portals are connected and they customize the sharing settings for each other, each portal can publish content and also grab content from other connected portals. They can grab this content and further build and customize their own internal travel portal/hub.

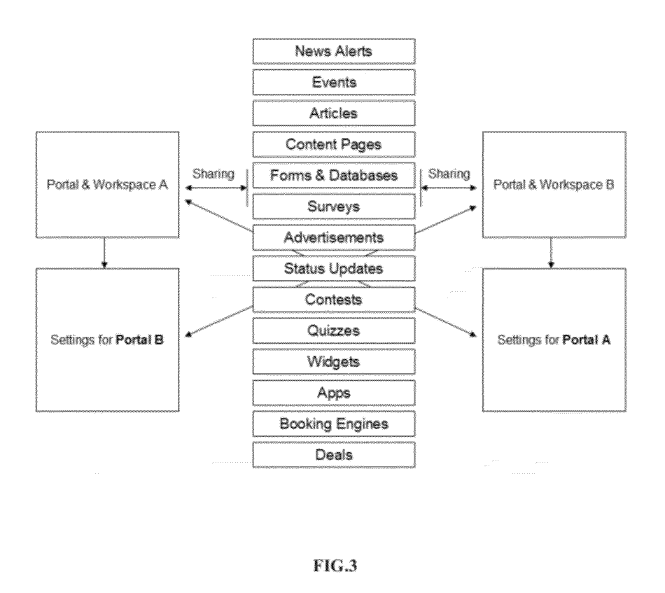

Portal administrators can further customize the permissions and settings per individual set or type of content per connection. For example, as shown in FIG. 3 they can approve Portal B alerts but not their content pages.

Groups

According to an embodiment of the present invention, portal administrators can create individual groups of users and connections. Groups can contain any set of users or external connected companies. Once a group is identified or created by a portal administrator, the group can quickly share content, apps, alerts, events, surveys, widgets, and more to a single group or multiple group(s).

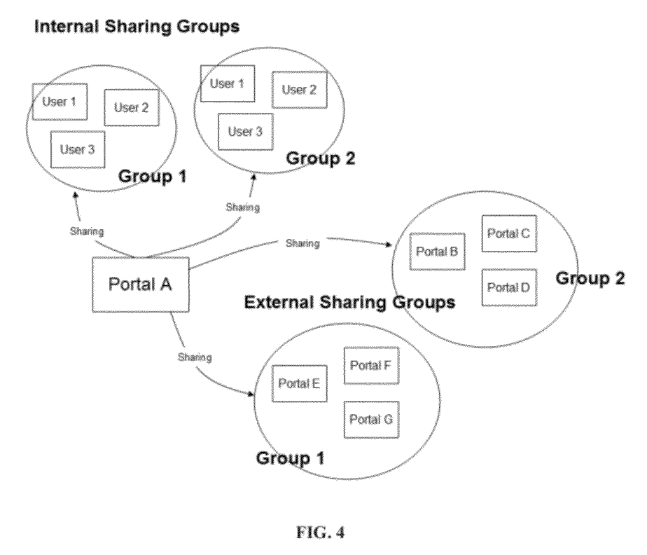

According to an embodiment of the present invention, groups can be either internal groups, external groups or any combination thereof. FIG. 4 shows an exemplary group diagram, in accordance with an embodiment of the present invention.

Audience Visibility

According to an embodiment of the present invention, when publishing content, the systems and methods herein described allow portal administrators to quickly choose and assign which connected portals, sets or sub sets of internal and external users can view selected content. The platform may also contain multiple sets of B2B and B2C views or user groups. The platform may contain multiple sets of private and public views or user groups as well.

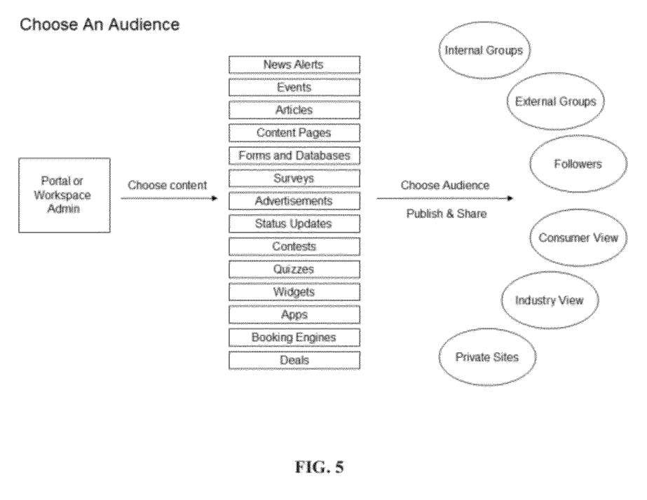

According to an embodiment of the present invention, each portal can easily choose which views, groups, sites or other set or subset of individuals/companies they wish to publish content, widgets, apps, and advertisements to. FIG. 5 shows an exemplary audience diagram, in accordance with an embodiment of the present invention.

Social Travel Preferences—Sharing of Travel or User Profile Preferences

According to an embodiment of the present invention, the systems and methods herein described comprises an online web based travel platform wherein, participants thereof are comprised of various types of travel service providers and customers. All participants are provided with user accounts within one or more networks that can be connected to each other for facilitating communication and collaboration there between. Each customer user account comprises a travel preferences section listing one or more travel preferences of a customer. Travel preferences of a customer can be accessed by those service providers whose user accounts are connected to the customer's user account and may be approved and provided an unlock key by the customer for access.

According to an embodiment of the present invention, each customer user account comprises a plurality of sections displaying different types of information or content. One of such sections may be a travel preferences section. The travel preferences section may contain, for example, information including, but not limited to, personal travel and hospitality preferences, likes and dislikes, personal interests and personal profile information data points. Each user can create and have multiple named travel preference schemas which each contain multiple individual travel preferences and data points. For example a user may create one travel preference schema for leisure traveling, one for business travel and one for local activities. The travel preferences section may be further categorized into various subsections wherein, each subsection pertains to a type of service provider. For example, a travel-preferences subsection may pertain to airlines, another travel-preference subsection may pertain to hotels, yet another travel-preference subsection may pertain to cruise lines, and a combination of some of the above categories may pertain to agents or agency. The travel preferences for each subsection maybe predefined wherein the customer may just need to ‘check’ or ‘fill in’ a preference, interest or personal profile information in order to select it. Alternatively, a customer is given a provision where he/she can manually input his/her personal preferences. The following are a few examples of traveler preferences, interests and personal profile information: Customer likes chocolates on their bed when they arrive at their suite (agency/hotel category); Customer likes their pasta extremely hot (agency/hotel/restaurant category); Customer likes ABC wine from Italy (agency/hotel/restaurant category); Customer likes a window seat when traveling long distances (agency/airliners/cruise lines category); Customer dislikes when hotel staff does not greet them by phone when he/she arrives at his/her room (agency/hotel category); Customer dislikes when waiters do not check on food when it arrives at table (agency/restaurant category); Customer likes outside cabins on cruise ships (agency/cruise lines category); Customer likes to have a basket of flowers delivered to their room when they arrive (hotel/agent category); and Customer likes mid-size cars (hotel/car rentals category); Customer likes bike riding; Customer likes hiking; Customer likes Beaches; Customer likes Fishing; Customer preferred form of payment is 376687878979XXX; Customers normal travel budget is $5000; Customers prefers high end hotels; Customer prefers travel during spring break time period; Customer prefers expensive restaurants; Customer always travels with a pet; Customer has two kids; Customers home address is 123 Street, Boca Raton, Fla., 33432. One of ordinary skill in the art would appreciate that there are numerous traveler preferences that may be used in accordance with embodiments of the present invention, and embodiments of the present invention are contemplated for use with any traveler preference.

According to an embodiment of the present invention, the systems and methods herein described may provide a web based platform configured such that travel preferences of a customer can only be accessed by service providers and or agencies whose user accounts are connected to the customer's user accounts. The web based platform may be further configured such that a service provider and/or travel agency can only view or access those customer travel preferences that pertain to his/her category. For example, an airliner can only view travel preferences subsection or subsections that pertains to airliners.

In another embodiment, a service provider needs permission from a customer to view the customer's travel preferences even though the service provider's site is connected to the customers' user account. The permission can be requested by the service provider and/or travel agency. Further, permission can be granted by the traveler or consumer to select vendors, merchants, travel agents, agencies and suppliers at the discretion of the user. In yet another embodiment, the travel preferences are broadly categorized into business travel preferences and leisure travel preferences, and etc, wherein, each of which in turn are further categorized into travel preferences that pertain to different types of service providers or travel suppliers as discussed earlier.

According to an embodiment of the present invention, in a case where types of types of travel suppliers (airliners, hotels, restaurants, cruise lines, etc) listed in the online network may not be all-encompassing, the web based platform may have a provision to introduce new travel supplier types. In one embodiment, a new travel supplier category can be introduced upon receiving a predetermined number of new travel supplier category addition requests. Once the criterion is met and the new category is introduced, a new set of travel preferences pertaining to that new category is associated with customer's user account wherein, the customer, as discussed earlier, can custom-configure the new set of preferences.

In yet another embodiment the web based platform can have additional data fields introduced within each travel preference category upon receiving a predetermined number of new travel supplier data field requests.

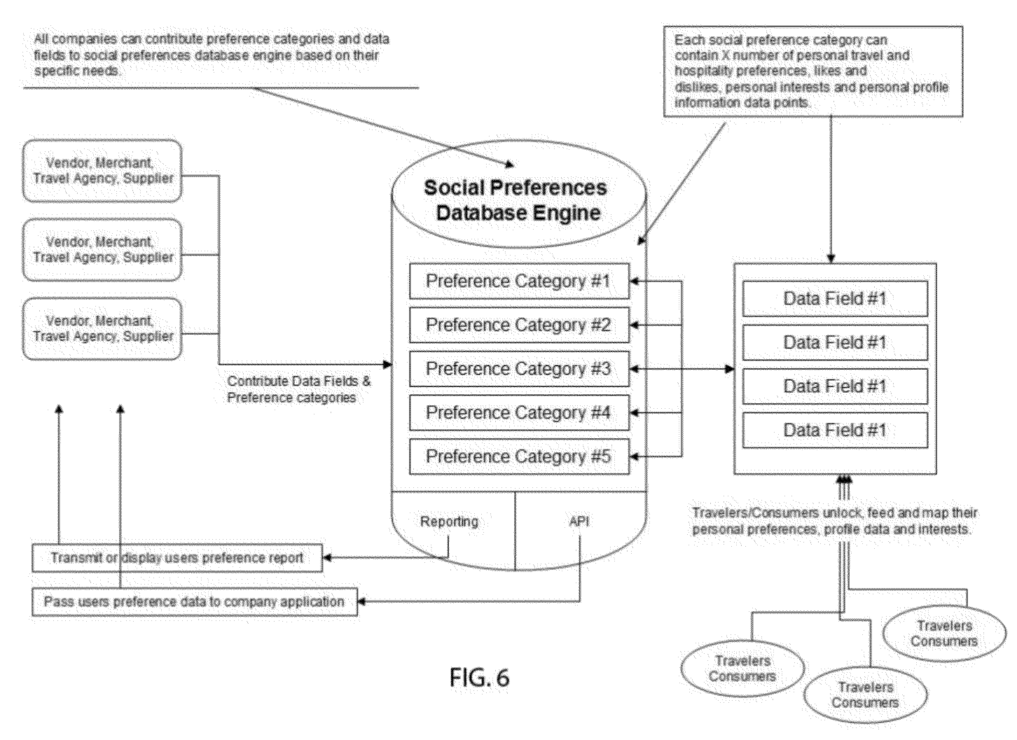

FIG. 6 shows a diagram displaying how travel agencies, travel suppliers, vendors and merchants can choose their preferred travel preference categories within the platform or recommend adding additional preference categories based on their needs, in accordance with an embodiment of the present invention. FIG. 6 also displays how each vendor, supplier or merchant can contribute, recommend and add additional data fields to each preference category. FIG. 6 also displays how the system provides an Application Programming Interface (API) available for third parties to pass data to and from the stored data on user preferences. The social travel preferences API can be used by travel agencies, vendors, suppliers and merchants to interface their company's existing web site, mobile app, legacy system, CRM, GDS, point of sale system, back office system, reservation or booking system or any other related front office, mid office or back office system or solution with the data stored within social travel preferences and related data points. One of ordinary skill in the art would appreciate that there are numerous methods of using APIs to allow third parties to pass data to and from various components of a system, and embodiments of the present invention are contemplated for use with any method for utilizing and incorporating APIs into the system.

According to an embodiment of the present invention, a preference system may be a dynamic system in the fact that it can grow, be edited and customized based on the requirements of agencies, suppliers, vendors and merchants.

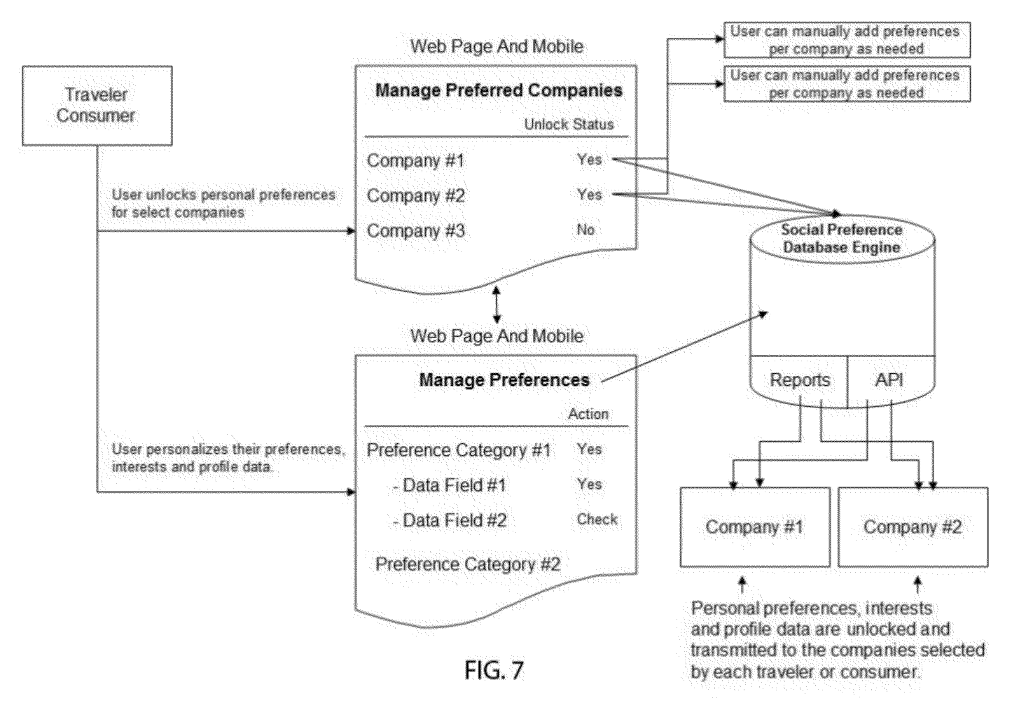

FIG. 7 shows a diagram displaying how travelers and customers within the web based platform can customize their individual preferences per preference category, in accordance with an embodiment of the present invention. The traveler and customer can further customize their own Individual preferences by entering their information into the available data fields within each preference category. Based on the suppliers, vendors, merchants and travel agents and agencies, the traveler and customer and provide an “unlock” key to approved accounts. Once the customer or traveler provides a unlock key to select suppliers, vendors, merchants, travel agents or agencies, they can then see, view and access the individual customers or travelers preferences. FIG. 7 also shows how the supplier, vendor, merchant, travel agency or travel agent can request an unlock key from customers or travelers. FIG. 7 also shows how the supplier, vendor, merchant, travel agency or travel agent can request and configure how they would like to receive message alerts and each individual travel or customer personal preferences. They can fully customize and configure whether they would like to receive individual detailed customer and traveler reports, instant alerts, daily digest or summary alerts. Alerts can be travel date based, location based or proximity based relative to users GPS location. For example a restaurant manager could be provided with a short text message or detailed email report when a new customer is about to enter their restaurant. Alerts can be received in the form of online profile display, mobile text message, email message, fax message and/or web based message. One of ordinary skill in the art would appreciate that there are numerous types of alerts and methods of delivering alerts that may be used with embodiments of the present invention, and embodiments of the present invention are contemplated for use with any type of alert and method of alert delivery.

Internal B2B and B2C Marketing and Advertising System

According to an embodiment of the present invention, each company that sets up a paid subscription and private portal plan within the travel platform may receive a certain number of included Ad credits. These Ad credits can be utilized to create and deploy self-service text, display and other ad types within the travel platform site and/or sites and views.

For example a company who chooses a $250 monthly subscription plan will also receive XX number of Ad credits. Each monthly subscription plan will provide a certain number of included Ad credits.

According to an embodiment of the present invention, each company may utilize a travel platform and their private portal to make a certain number of connections with other companies on the platform. Once a connection is made and the other company approves the connection, each company can decide whether they would like to approve and accept the others Ads. If they accept, then the other companies Ads will be displayed within their portal and to their users.

According to an embodiment of the present invention, each company may be provided with an incentive to accept each other's Ads, as the system provides additional Ad credits based on the number of other companies Ads which are approved or accepted. For example, if Company A accepts 25 other companies Ads to be displayed within the private portal and to Company A's user base, then Company A will received additional Ad credits based on the number of approved connections and/or approved Ads. The additional Ad credits earned will be based on either the number of connections in which Ads were approved or the number of impressions generated by the display of ads within Company A's portal.

According to an embodiment of the present invention, each company can decide, among other things, to accept or decline to accept Ads being displayed by their connections. An example provides that if Company B has 100 connected companies which have accepted to receive their ads, then when Company B creates and deploys its Ads they will be displayed on all 100 connected company private portals which accepted to receive them.

According to an embodiment of the present invention, each company can decide whether they wish to deploy their Ads using a CPC or CPM or cost per lead method or any other related online or mobile ad type. Ads may be displayed within each company's internal private portal, custom internal and external views and also individual user mobile phones as well. All Ads can also be targeted by keywords, locations, social travel preferences and other specific data fields. Ads can either be targeted or run-of-site.

According to an embodiment of the present invention, the travel platform may also offer a method for each company and its users to earn more Ad credits by exchanging expertise points, badges and general points earned for Ad credits.

According to an embodiment of the present invention, users can earn expertise points by answering questions and taking quizzes within the platform. Users and companies can earn badges from companies for performing an excellent work, task, action or service. Other general points can be earned within the travel platform for taking certain actions. As users earn points or badges within the platform, the user can decide to redeem or exchange available points for additional Ad credits.

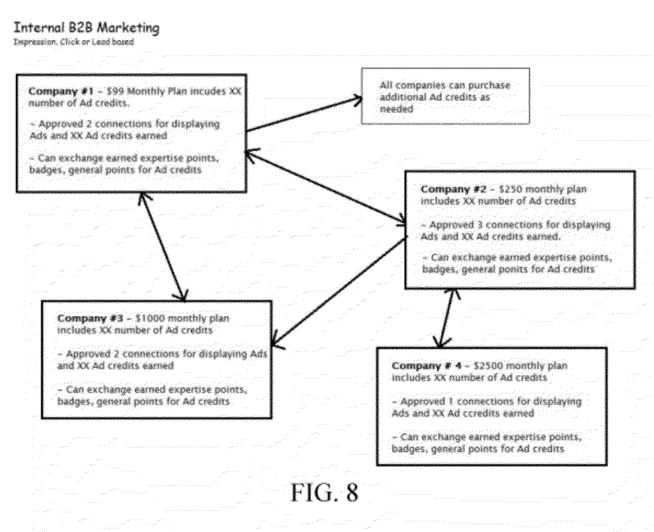

According to an embodiment of the present invention, all users and companies can purchase additional Ad credits as needed. FIG. 8 shows a diagram of an exemplary embodiment of an Internal B2B Marketing connection, in accordance with an embodiment of the present invention.

External “Group Buying” Marketing and Advertising System

According to an embodiment of the present invention, the systems and methods herein described may be configured to provide a travel platform that provides an external group buying advertising system which allows for the following abilities: providing all companies who have a monthly subscription can decide to purchase or fund specific targeted keywords and or locations; when a certain number of companies fund a keyword or when a certain dollar amount has been reached on a specific keyword or location, then the third party Advertising agency will activate a marketing campaign per this keyword or location. Until a certain threshold has been reached on specific keywords or location then no Ad campaigns will be generated.

The third party Advertising agency will create and deploy Ads external to the travel platform. The Ads will be deployed on Radio, mobile, TV, Online, social media, print and many other types of media.

The external Ads will be targeted to the specific keyword or location and include specific branding of the travel platform and or specific companies included in the funding of that keyword or location.

The external Ads will direct consumers and or travelers to specific landing pages, internal pages, signup pages, Phone call pages, lead generation pages and other types of promotional pages displayed online or on mobile devices.

The number of leads, phone calls, call to action pages, and other lead generation pages will be displayed and generated for each advertiser based on the amount of funds they have applied to each keyword or location. For example, Company A provided $50 dollars towards a keyword of “Caribbean Cruises” and Company B provided $100 towards this same keyword. So, Company A would receive the exact percentage of leads, calls, impressions, clicks etc that their $50 is entitled based on what percentage Company A funds are to the whole sum of all advertisers funding “Caribbean Cruises” Company B would receive the exact percentage of the same based on their $100 funding. In this example, a total of $150 dollars was funded for ‘Caribbean Cruises” targeted keyword. Company A funded exactly 33.3% of the total funds provided by all advertisers. So Company A will receive 33.3% of the distributed leads, phone calls, ad displays, impressions, clicks, etc.

If Company A and Company B provide the same exact amount of funds for a particular keyword or location then the incoming call, lead, call to action, impression etc will be provided to the company who has a higher monthly subscription plan. If they both also have the same monthly subscription plan then other means will be used to distribute the lead, click, call, impression or similar to the correct company.

All companies will be provided with a transparent view of the exact amount of funds which have been provided per keyword and location and which companies provided the funds as well. All advertisers will also be provided with an online view of each keyword and location they are targeting and the exact Ads, Ad descriptions, Ad copy and samples, and marketing campaigns that have been deployed by the third party Ad agencies.

Multiple third party Advertising agencies and marketing partners will be provided with web based admin and management views of this external group buying system. The admin view provides a means for the third party Ad agencies to enter the generated and deployed Ads for each keyword or location. So for example if the third party Ad agency deploys a print Ad for the keyword ‘Caribbean Cruises’ then the Ad agency can provide the specific details on this generated Ad such as cost, circulation, supplier, image sample, hyperlink etc. This information will be provided to all advertisers that fund “Caribbean Cruises” keyword.

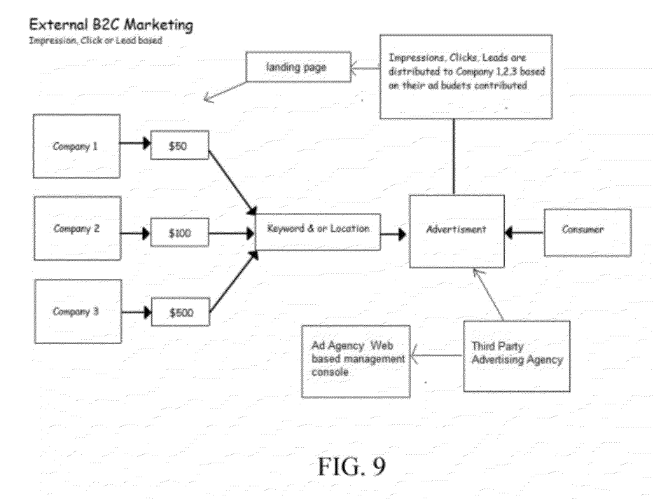

One of ordinary skill in the art would appreciate that the collective advertising purchasing methods and systems described herein would work with any number of advertising sectors, and embodiments of the present invention are contemplated for use with any advertising sector. FIG. 9 shows a diagram of an exemplary advertising purchasing method and system in accordance with an embodiment of the present invention.

Open Traveler/Consumer Travel Management Application

According to an embodiment of the present invention, the system and methods herein described may provide an Open Traveler/Consumer Travel Management Application. The Open Traveler/Consumer Travel Management Application is a unique approach to presenting a user with an online travel web site, service and solution. The vast majority of online travel web sites, travel reservation systems and travel reservation applications provide a user with a fixed array or set of suppliers/merchants/vendors to choose from. These suppliers/vendors/merchants are normally chosen by the web site or application provider.

The Open Travel/Consumer management view takes a very different and unique approach allowing each user to communicate and collaborate with the vendors/merchants/suppliers of their choice. If a vendor/supplier/merchant is not available in the platform and the user would like to work, communicate or collaborate directly with said vendor/supplier/merchant then the user can utilize the invite process built into the platform to invite the vendor/supplier/merchant into the platform.

The user is presented with an online travel management platform of their own. Once registered and logged in, the user can pick and choose which suppliers/vendors/merchants he/she wishes to communicate and collaborate with. The user can then further pick and choose which applications, widgets, tools, booking systems, content, etc they wish to receive and utilize.

All of the chosen suppliers/merchants/vendors and associated applications, widget, tools, booking systems, content and more are displayed, organized and provided within the user's customized and personalized Travel Management Application online or via a mobile app. Additionally, certain features may be provided offline, allowing a user to create/view data offline and synchronize said data when the user is capable of accessing online or mobile networks.

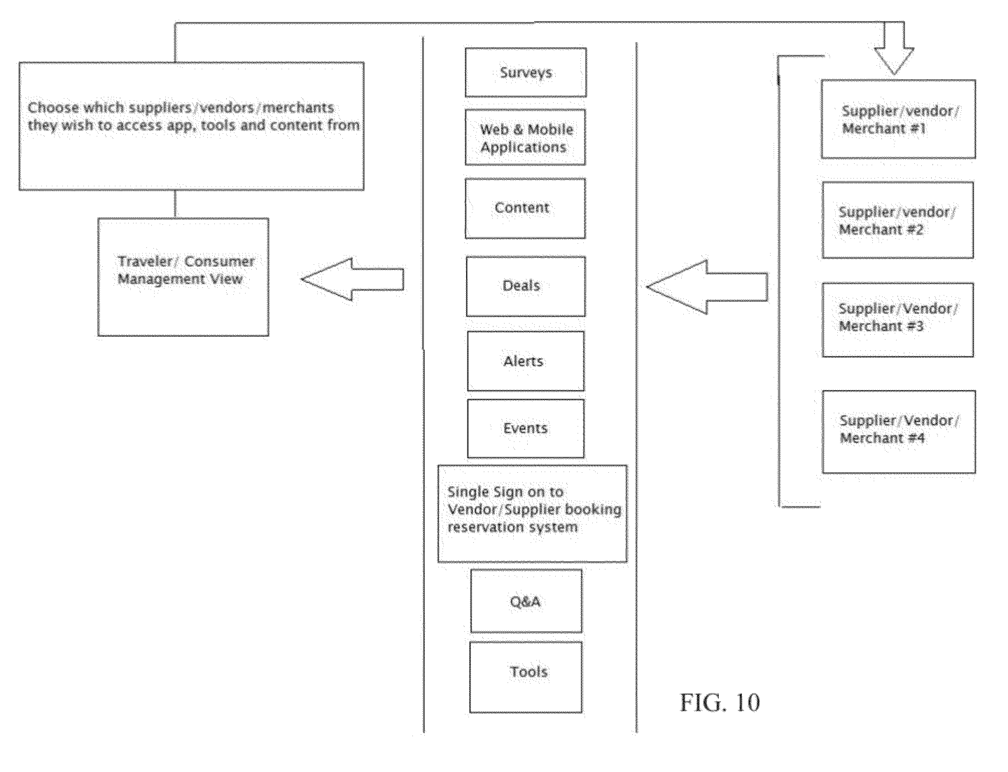

FIG. 10 shows a diagram of an exemplary Open Traveler/Consumer Travel Management Application in accordance with an embodiment of the present invention. According to an embodiment of the present invention, key points of the Open Traveler/Consumer Travel Management Application include, but are not limited to: Consumer/Traveler can pick and choose which vendors/supplier/merchants they wish to communicate and collaborate with; Consumer/Traveler can pick and choose which applications, widgets, tools, travel booking systems, content, alerts and other components they wish to view and utilize; Traveler/Consumer can invite any supplier/merchant/vendor worldwide for which he/she wishes to communicate and collaborate with and they can then proceed to follow the invited vendor/supplier/merchant once they have joined the platform; the Consumer/Traveler can also pick and choose from provided mobile and web based applications within the platform's application store or marketplace and these applications will be aggregated from all available vendors/suppliers/merchants within the platform; the Consumer/Traveler can further customize which type of specific content, applications, travel reservation systems, widgets, alerts, news and other information they wish to receive from each chosen vendor/merchant/supplier; the Vendor/Supplier/Merchants can provide users with access an online reservation or booking system provided by said Vendor/Supplier/Merchant and once provided, a user can then enter his/her login credentials for said travel booking or reservation system and once the user login credentials are stored within the platform the user can then auto login or single sign on to his/her preferred vendor/supplier/merchant travel booking or reservations systems. For example, user A can choose to connect with or follow Major Travel Web Site #1 and Major Travel Web Site #2. The chosen vendor/supplier/merchant can then provide single sign on or auto login access to the user. The user can store their login credentials within his/her personal Travel Management View. The user can then easily auto login to the online travel reservation or booking systems of either Major Travel Web Site #1 and/or Major Travel Web Site #2.

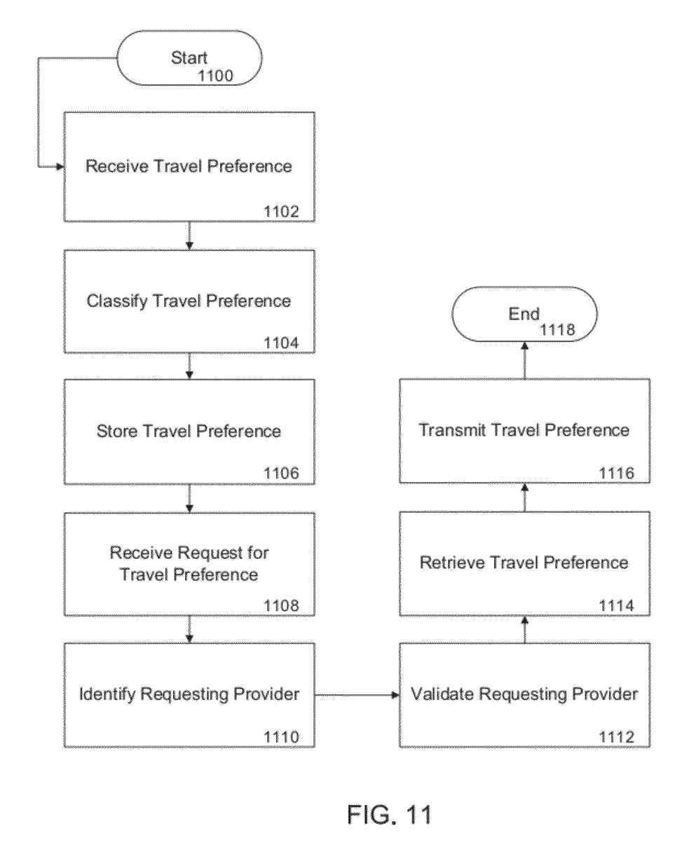

Turning now to FIG. 11, an exemplary method for providing a travel ecosystem with social travel preferences, in accordance with an embodiment of the present invention, is shown. At step 1100, the process starts. At step 1102, the system receives one or more travel preferences from a user. As noted above, travel preferences can be along the lines of: “Customer likes chocolates on their bed when they arrive at their suite” (Category: agency/hotel category); “Customer likes their pasta extremely hot” (Category: agency/hotel/restaurant category); “Customer likes ABC wine from Italy” (Category: agency/hotel/restaurant category); “Customer likes a window seat when traveling long distances” (Category: agency/airliners/cruise lines category); and/or “Customer dislikes when hotel staff does not greet them by phone when he/she arrives at his/her room” (Category: agency/hotel category). This can happen over time as well such that the system develops a deep understanding of the user and the user's tastes/preferences.

At step 1104, the system is configured to classify these travel preferences as pertaining to one or more applicable categories. As noted above, the categories could denote that the particular preference is related to hotels, restaurants, cruise ships or any other identifier that may be appropriate for the particular preference.

At step 1106, the system is configured to store the travel preferences and applicable categories in a data store of a travel preference engine. The travel preference engine is a component of a web-based system that may be comprised of both hardware and software configured to execute on the hardware in such a manner to effect the hardware to take certain actions with respect to the data and machine functions operable therefrom.

At step 1108, the system receives a request from a travel provider or from a traveler. The request is directed to transmitting information regarding a user and their travel preferences. In an example, this may occur when a travel service provider receives a request from the user to perform some action on a travel service request, or when a travel service provider is preparing an advertisement, solicitation or other communication with a particular user. In a preferred embodiment of the present invention, this request is initiated by a user who is “unlocking” their preferences to one or more travel providers. In this manner, the user is making their preferences available to one or more travel service providers.

At step 1110, the system is configured to identify the travel provider from information contained in the request. For instance, the request may contain a unique identifier (e.g., GUID) or a username and password combination. One of ordinary skill in the art would appreciate that there are numerous manners in which the system can identify the travel provider, and embodiments of the present invention are contemplated for use with any method of identifying a travel provider.

At step 1112, The system validates the travel provider that made the request to make sure they are permitted to access the user's preferences/information. The information may be protected in various manners, as described in detail above. For instance, even where a user's information is not secured by password or requirement that a particular service provider be authorized, particular preferences may only be accessible to travel service providers that are in an appropriate category (e.g., a restaurant service provider may not be able to access flight preferences of a user, but may have access to food preferences of the user).

At step 1114, assuming the validation step was successful, the system retrieves, from the data store, the travel preferences requested by the travel service provider. At step 1116, the system transmits the travel preferences to the travel service provider and the process then terminates at step 1118.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While the present invention is described with a focus on the travel industry, one of ordinary skill in the art would appreciate that embodiments of the present invention may be utilized in any number of industries and embodiments of the present invention are contemplated for use in any such industry.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A web-based system for providing a travel ecosystem with social travel preferences, the system comprising:
a travel preference engine comprising computer-executable code stored in non-volatile memory, a data store and a travel preference communications means; and
a communications engine comprising computer-executable code stored in non-volatile memory and a communications engine communications means,
wherein said communications engine communications means is configured to communicate data from said travel preference engine to one or more travel providers and one or more travelers,
wherein said computer-executable code of said travel preference engine is configured to perform the steps of:
receiving one or more travel preferences from said one or more travelers;
classifying said one or more travel preferences as pertaining to one or more applicable categories;
storing said one or more travel preferences and one or more applicable categories in said data store of said travel preference engine;
Receiving a request from one or more of said one or more travel providers, wherein said request is to receive information regarding said one or more travel preferences of said one or more travelers;
identifying said one or more travel providers from said request, wherein said identification further identifies one or more industries associated with said one or more travel providers;
validating one or more of said one or more travel providers based at least in part on information related to said one or more travel providers stored in said data store and a comparable matching between said one or more applicable categories and said information;
retrieving, from said data store, one or more of said one or more travel preferences;
transmitting to one or more of said one or more travel providers said one or more of said one or more travel preferences.

2. The web-based system of claim 1, wherein said one or more travel providers and one or more travelers are provided user accounts within one or more networks that can be connected to each other for facilitating communication and collaboration there between.

3. The web-based system of claim 2, wherein each user account associated with one or more of said one or more travelers comprises a travel preferences section, stored in said data store, listing one or more travel preferences of said one or more of said one or more travelers.

4. The web-based system of claim 2, wherein each user account comprises a plurality of sections displaying a plurality of types of information.

5. The web-based system of claim 1, wherein said one or more travel preferences may be selected by said one or more travelers by checking a preference in order to select it.

6. The web-based system of claim 1, wherein said one or more travel preferences may be selected by manual input.

7. The web-based system of claim 1, wherein said validating step requires permission to be granted from said one or more travelers.

8. A web-based method for providing a travel ecosystem with social travel preferences, the method comprising the steps of:
receiving one or more travel preferences from one or more travelers;
classifying said one or more travel preferences as pertaining to one or more applicable categories;
storing said one or more travel preferences and one or more applicable categories in a data store of a travel preference engine;
receiving a request from one or more of said one or more travel providers and one or more travelers, wherein said request is to receive information regarding said one or more travel preferences of said one or more travelers;
identifying said one or more travel providers from said request, wherein said identification further identifies one or more industries associated with said one or more travel providers;
validating one or more of said one or more travel providers based at least in part on information related to said one or more travel providers stored in said data store and a comparable matching between said one or more applicable categories and said information;
retrieving, from said data store, one or more of said one or more travel preferences;
transmitting to one or more of said one or more travel providers said one or more of said one or more travel preferences.

9. The web-based method of claim 8, wherein said one or more travel providers and one or more travelers are provided user accounts within one or more networks that can be connected to each other for facilitating communication and collaboration there between.

10. The web-based method of claim 9, wherein each user account associated with one or more of said one or more travelers comprises a travel preferences section, stored in said data store, listing one or more travel preferences of said one or more of said one or more travelers.

11. The web-based method of claim 9, wherein each user account comprises a plurality of sections displaying a plurality of types of information.

12. The web-based method of claim 8, wherein said one or more travel preferences may be selected by said one or more travelers by checking a preference in order to select it.

13. The web-based method of claim 8, wherein said one or more travel preferences may be selected by manual input.

14. The web-based method of claim 8, wherein said validating step requires permission to be granted from said one or more travelers.

15. A web-based system for providing a travel ecosystem with social travel preferences, the system comprising:
a travel preference engine comprising computer-executable code stored in non-volatile memory, a data store and a travel preference communications means; and
a communications engine comprising computer-executable code stored in non-volatile memory and a communications engine communications means,
wherein said communications engine communications means is configured to communicate data from said travel preference engine to one or more travel providers and one or more travelers,
wherein said computer-executable code of said travel preference engine is configured to perform the steps of:
receiving one or more travel preferences from said one or more travelers;
classifying said one or more travel preferences as pertaining to one or more applicable categories;
storing said one or more travel preferences and one or more applicable categories in said data store of said travel preference engine;
Receiving a request from one or more of said one or more travelers, wherein said request is to receive information regarding said one or more travel preferences of said one or more travelers;
identifying said one or more travel providers from said request, wherein said identification further identifies one or more industries associated with said one or more travel providers;
validating one or more of said one or more travel providers based at least in part on information related to said one or more travel providers stored in said data store and a comparable matching between said one or more applicable categories and said information;
retrieving, from said data store, one or more of said one or more travel preferences;
transmitting to one or more of said one or more travel providers said one or more of said one or more travel preferences.

16. The web-based system of claim 15, wherein said one or more travel providers and one or more travelers are provided user accounts within one or more networks that can be connected to each other for facilitating communication and collaboration there between.

17. The web-based system of claim 16, wherein each user account associated with one or more of said one or more travelers comprises a travel preferences section, stored in said data store, listing one or more travel preferences of said one or more of said one or more travelers.

18. The web-based system of claim 17, wherein each user account comprises a plurality of sections displaying a plurality of types of information.

19. The web-based system of claim 18, wherein said one or more travel preferences may be selected by said one or more travelers by checking a preference in order to select it.

20. The web-based system of claim 19, wherein said one or more travel preferences may be selected by manual input.
